(19) United States
(12) Patent Application Publication
(10) Pub. No.: US 2011/0085030 A1
(43) Pub. Date: Apr. 14, 2011

(54) IMAGE SENSING SYSTEM, SOFTWARE, APPARATUS AND METHOD FOR CONTROLLING COMBUSTION EQUIPMENT

(75) Inventors: Roger L. Poe, Beggs, OK (US); Joseph Colannino, Tulsa, OK (US); Jianhui Hong, Tulsa, OK (US)

(73) Assignee: John Zink Company, LLC, Tulsa, OK (US)

(21) Appl. No.: 12/899,108

(22) Filed: Oct. 6, 2010

Related U.S. Application Data
(60) Provisional application No. 61/278,591, filed on Oct. 7, 2009.

(51) Int. Cl. H04N 7/18; G06K 9/00

(52) U.S. Cl. 348/61; 382/103

(57) ABSTRACT

In one aspect, the invention provides an automatic control system that includes an optical image capture device as part of an imaging system. In another aspect, the invention provides an imaging system that can control a flame generation system utilizing an optical image capture device in connection with a computer system, including software (and corresponding algorithms), and related apparatus as necessary. The system can be used to control various aspects of flame generating equipment such as flares, burners, pilots and other combustion equipment. Qualitative and quantitative analyses of flames, for example, can be carried out. In another aspect, the invention provides a specific methodology for using the inventive image sensing control system.

### CROSS-REFERENCE TO RELATED APPLICATION

This application claims the benefit of the filing date of provisional application Serial No. 61/278,591, entitled “Image Sensing System, Software, Apparatus and Method for Controlling Combustion Equipment,” filed Oct. 7, 2009, the contents of which are incorporated herein by reference.

### BACKGROUND

In accordance with the present invention, imaging systems are used in association with flame generating combustion equipment such as industrial flares, burners and pilots to control the operation of the flame generating combustion equipment in an open-air environment.

In industrial flares (e.g., waste gas flares), some of the major design points include hydraulic capacity, smokeless capability, destruction efficiency, combustion efficiency, flare-gas composition, degree of air entrainment, mechanical efficiency of associated equipment such as steam nozzles, air fans, blowers, and compressors, and the need to provide ignition. Optimal performance requires balancing the above parameters at both maximum and minimum flow rates. Flare operators typically desire a maximum flow rate through the flare tip, which is referred to as the hydraulic capacity. Flare operators also desire a lower flow rate where flaring occurs without soot or smoke, which is referred to as the smokeless capacity of the flare tip. Operators are also required to destroy about 98% or more of flare gas to ensure the safety of the effluent discharged by the flare. This percentage is called the destructive removal efficiency, or destruction efficiency.

The dilution rate is the amount of air and/or steam added to the gas being flared. Air and/or steam serve to entrain additional surrounding air to aid in combustion of flare gas. However, adding too much air or stream to the flare can result in a condition known as over-aeration, or over-steaming. Indeed, some portions of flare gas can be over-aerated or over-streamed to the point that it is no longer combustible, thereby reducing efficiency of the flare.

Steam or air assistance is usually employed to facilitate the mixing required to achieve the aforementioned smokeless capacity. Steam flares make use of high velocity steam to aid mixing and entrain air. The design of the steam portion of the flare is generally such that the air and steam are distributed through nozzles or mixing tubes as the gas leaves the steam flare tip. The purpose of the steam is to serve as a motive fluid to entrain additional surrounding air. Some steam or air is distributed inside the flare tip as purge gas to prevent the flame from burning inside the tip. Excessive steam and or air can create a non-combustible mixture thereby reducing the flare efficiency.

Flare tips can be damaged if, or when, a flame is allowed to stabilize inside the tip. This typically happens when flare gas flow rates are low, or when very low purge rates are used. As a result, the steam distributed inside the flare tip continuously flows all of the time.

Operators are currently turning the steam up higher than prescribed so that the tip needs less intervention during small flaring events. However, the steam flow may have the potential to quench the gas stream and/or cause the gas stream to become inert to the point that the gas does not oxidize. This can allow a potentially hazardous stream to flow to the atmosphere and reduce the flare efficiency.

In cold climates, air is preferred because the steam may freeze. This type of flare delivers a large capacity of air to the flare tip by one or more large, electrical fans having multi-hundred horsepower motors. A large flare may have four or more fans delivering the air to tip. At least one or more of these fans will be a two-speed fan, and will run 100% of the time while the remaining fans are idle, waiting for a flaring event. This two-speed fan handles small process or purge rate flows. The net cost for the electrical energy to run the two-speed fan all of the time is appreciable.

Even at low or half-speed, a vane axial fan in an air flare may deliver more than sufficient air flow. Normal purge rate flows associated with leaking valves and processes that are upstream of the tip can produce an appreciable gas flow to the flare. However, purge rate flow velocities associated with the gas, can be under one about foot per second (about 0.3 meters per second) for a large tip. A fan running at half speed can potentially deliver a sufficient flow rate of air to produce non-flammable or stratified mixtures of gas and air to the flare tip. The potential for unoxidized effluent from the tip then becomes a problem and may violate environmental requirements. Destruction efficiencies can be reduced to levels below acceptable requirements if purge or leak rates are lower than expected.

### SUMMARY

In one aspect, the invention provides a flare control system. The flare control system comprises an optical-based imaging system and an automated flare control processor. The optical-based imaging system includes at least one image capture device oriented toward at least one flare being ambiently discharged, and an image processor. The image processor includes at least one image processing algorithm capable of electronically analyzing a captured image of the flare, and capable of discriminating between the flare and an ambient background. The automated flare control processor defines a control system for the flare, wherein the automated flare control processor controls the flare in response to analysis received from the image processor.

In another aspect, the invention provides for a flare controller comprising at least one flare, an image processing system, and an automated flare control processor. The flare is ambiently discharged into the atmosphere. The imaging system includes at least two optical image capture devices, an image processor, at least one image processing algorithm, and an electronic output. And, at least one optical image capture device detects, locates and captures a flame in the flare. At least one optical image capture device captures an electronic image of the flame. The image processor is at least a computer in electronic communication with the optical image capture devices. The image processing algorithm is hosted on the image processor, and is adapted to analyze the electronic image, wherein the image processing algorithm discriminates between the flare and the atmosphere. The electronic output generated by the image processor identifies at least one performance parameter of the flare. The automated flare control processor receives the electronic output, and the flare control processor generates a responsive control input to a flame generation system that includes the flare, or digital control system providing input to that same flame generation system.

In another aspect, the invention provides for an automatic flare control system comprising at least one flare, an imaging system and a computer system. The imaging system is capable of electronically capturing a digital image of a flame generated by the flare. The computer system includes software for analyzing the image captured by the imaging system.

In one aspect, the invention includes an automated flare control system that includes an image sensing device.

In another aspect, the invention is an imaging system that utilizes an image sensing device in connection with a computer system, including software (and corresponding algorithms), and related apparatus as necessary. The system can be used to control various aspects of flame generating equipment such as flares, burners, pilots and other combustion equipment. Qualitative and quantitative analyses of flames can be conducted.

The image sensing device can be or include a digital video camera or other type of camera capable of recording a series of sequential events. For example, in one embodiment, the image sensing device is a camera that is capable of creating images in which pixels in the visual spectrum can be counted. Digital cameras as well as analog cameras that create images which can be converted into digital images can be used. In one embodiment, a digital video camera is utilized.

In another aspect, the invention provides a specific methodology for using the inventive imaging system.

In yet another aspect, the inventive method provides for the control of a flare being discharged in the open-air ambient environment through optical imaging. The method comprises the following steps:
(a) discharging a flare in an open-air ambient environment;
(b) monitoring the flare using an optical-based imaging system having at least one camera;
(c) capturing the image of the flare as an electronic image using the camera;
(d) analyzing the electronic image of the flare using at least one algorithm adapted to precursorily predict smoke, and at least one algorithm that is capable of discriminating between the flare and the open-air ambient environment; and
(e) adjusting the flare based upon an analyzed condition of the flare.

### BRIEF DESCRIPTION OF THE DRAWINGS

FIG. 1 is a schematic view of a plurality of flares with an imaging system.

FIG. 2 depicts the rendered flame image from the flare in FIG. 1 and the inverted flame image.

FIG. 3A depicts a nighttime screen image capture of a flare with an un-zoomed, visible, charged-coupled device camera with a target box.

FIG. 3B depicts a nighttime screen image capture of a flare flame from FIG. 3A using an infrared camera and a target box of the visible flare depicted in FIG. 3A.

FIG. 4A depicts a nighttime screen image capture of a flare having no visible flame and using an un-zoomed, visible charged-coupled device camera with a target box.

FIG. 4B depicts the nighttime screen image capture of the flare flame in FIG. 4A using an infrared camera and a target box of the visible flare depicted in FIG. 3A.

FIG. 5A depicts the connectivity of the imaging process.

FIG. 5B depicts the connectivity of the flame generation and feedback control loop.

FIGS. 6A and 6B depict a flare operating with a low flame quality ratio and emitting smoke.

FIGS. 7A and 7B depict a flare operating at a desired flame quality ratio.

FIG. 8 depicts an aerated flame with a flame quality ratio bar graph superimposed thereon.

FIG. 9 depicts a flare emitting smoke as seen during a field test.

FIGS. 10A and 10B depict the time history of the flame quality ratio of the field-tested flare depicted in FIG. 9.

### DETAILED DESCRIPTION

In connection with the present invention, it has been discovered that an optical imaging system using visible and infrared imaging devices can be utilized in connection with flame generating equipment such as flares, burners, pilots and other combustion equipment to help monitor and control operation of the flame generating equipment in the open atmosphere in an effective and efficient manner. The optical imaging system helps monitor and control operations, as well as providing precursory smoke prediction in enclosed or aesthetic flares or burners, also known as ground flares.

Referring to the drawings, the inventive image sensing system encompasses a flare control system. The flare control system is illustrated and generally designated by the numeral 10. As shown by the drawings and understood by those skilled in the art, flare control system 10 and components thereof are designed to be associated with at least one flare 12, or at least one flare 12 operating within at least one burner 14. Flare 12 and/or burners 14 are part of the flame generating combustion equipment utilized in ambient environment 16 for the petroleum, chemical or other industries utilizing flares 12 and/or burners 14. Flares 12 and/or burners 14 are open-air flares and/or burners, or enclosed or aesthetic flares and/or burners. Preferably, flare control system 10 is automated.

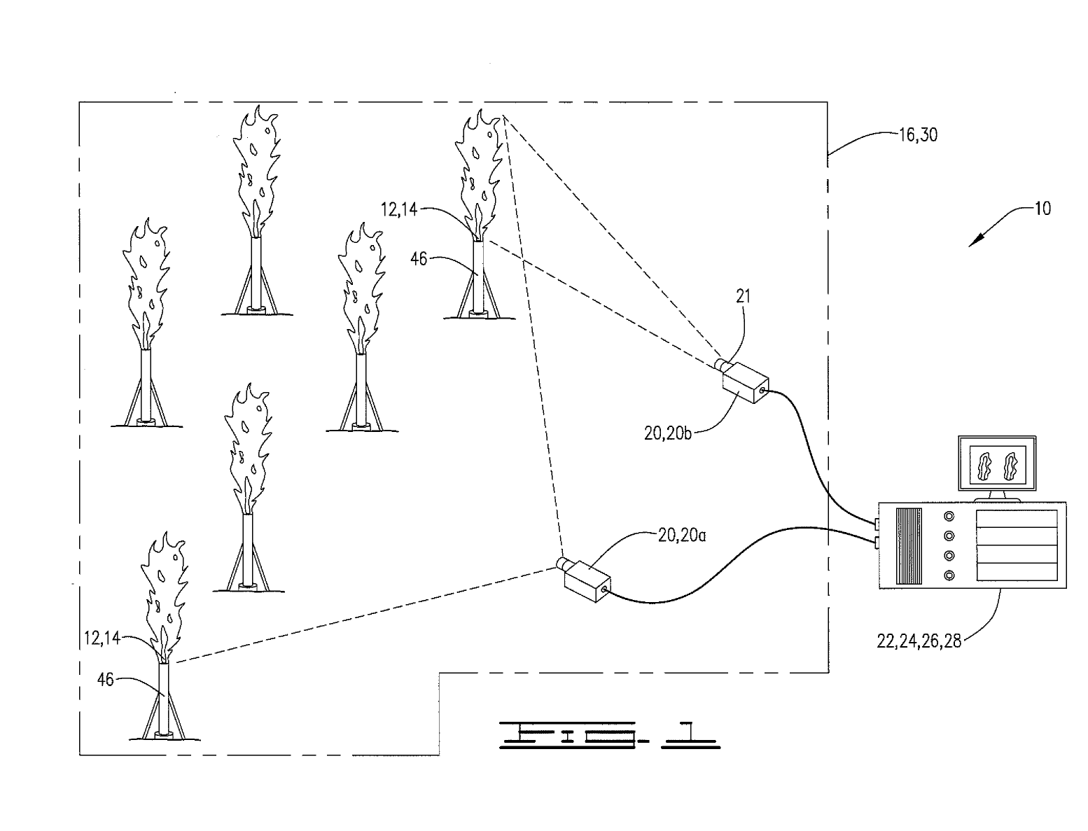

Referring to FIGS. 1, 2, 5A and 5B, flare control system 10 includes imaging system 18. Imaging system 18 is an optical-based imaging system that includes at least one optical image capture device 20, also referred to as camera 20, oriented toward flare 12 or burner 14, camera controller 22, image processor 24, and any applicable software necessary to operate the foregoing hardware and perform the necessary analysis. Camera controller 22 and image processor 24 may be integrated as a single unit, and referred to as image processor 24.

FIG. 1 illustrates cameras 20 and the fields of view therefrom. As illustrated, camera 20 includes a plurality of cameras having zoom lens 21, with at least a first camera 20a and at least a second camera 20b. In FIG. 1, the dashed lines represent a field of view from first camera 20a and second camera 20b. In one embodiment camera 20 is a multi-charge-coupled device (CCD) camera using a prism (not shown), an optical beam-splitter (not shown), or a wavelength filter (not shown) to split the incoming light into different spectral light groupings upon the CCD array.

In one embodiment, first camera 20a and second camera 20b are selected from the group consisting of CCD cameras, multi-CCD cameras, multi-spectral cameras, high-definition cameras, digital cameras, analog cameras, color cameras, black and white cameras, grey-scale cameras and combinations thereof. In one embodiment, first camera 20a is a broad-spectrum infrared camera. In another embodiment, first camera 20a is a near-infrared camera. In one embodiment, first camera 20a is a short-wavelength infrared camera. In one embodiment, first camera 20a is a mid-wavelength infrared camera. In one embodiment, first camera 20a is a long-wavelength infrared camera.

In one embodiment, second camera 20b operates in the visible spectrum, or a portion thereof. In another embodiment, second camera 20b operates in the visible-to-ultraviolet spectrum, or a portion thereof.

First camera 20a and second camera 20b are in electronic communication with camera controller 22 and image processor 24. First camera 20a is adapted to detect, locate and electronically capture an image of flare 12 and/or burner 14. First camera 20a identifies and acquires flare 12 or burner 14, and distinguishes between a plurality of flares 12 or burners 14. Second camera 20b is adapted to electronically capture an image associated with flare 12 and/or burner 14, which includes a flame therewith. First camera 20a defines and generates at least one aiming parameter for second camera 20b, and electronically communicates those parameters to camera controller 22, thereby communicating through the imaging system 18.

Numerous cameras, filters, beam splitters or other optical devices in various combinations all work. In one embodiment, if camera 20 is at least a multi-spectral or multi-CCD camera, then a single camera 20 may be utilized. In that embodiment, light from flare 12 and/or burner 14 is split upon entering camera 20. In such instances, a prism (not shown) or other optical-based light management device is used to split the incoming light into two or more beams, wherein at least one beam is analyzed in the near infrared and at least the other in the visible spectrum. Other spectral components or ranges may also be used alone or in combination, such as far infrared, medium infrared, infrared, near-infrared, visible, near-ultraviolet, ultra-violet, or any portion of a wavelength desired. The performance of imaging system 18 is improved and more robust when camera 20 has higher quality components such as improved optics attached to and/or within.

First camera 20a and second camera 20b may use a separate lens to widen or narrow the field of view. Alternatively, first camera 20a and second camera 20b have a zoom function to adjust the field of view. FIG. 1 illustrates camera 20b zooming in upon flame 56 of flare 12.

Camera controller 22, or image capture control system 22, defines the control parameters of the image capture devices, or cameras 20. This control includes operational control, and control of the electronic communications therebetween. The electronic communication between camera controller 22, first camera 20a and second camera 20b ensures real-time, interactive control to and between each camera 20a and 20b. Camera controller 22 interactively adjusts zoom lens 21. Camera controller 22 is adapted to focus zoom lens 21 on flame 56 to maximize the number of pixels available for statistical analysis. The greater the number of pixels used in image processing algorithms 26, the greater the precision of the results.

Camera controller 22 is in electronic communication with image processor 24. Image processor 24 is a computer-based system having software hosted on computer 28 for processing digital images captured therein, and having at least one image processing algorithm 26, also hosted thereon. Computer 28 is in electronic communication with optical image capture devices 20 and/or camera controller 22. Camera controller 22 is part of image processor 24.

Preferably, image processing algorithm 26 is software hosted on computer 28 and capable of electronically analyzing the captured image from flare 12 and/or burner 14. Additionally, image processing algorithm 26 is capable of discriminating between flare 12, or burner 14, and ambient environment 16, such as against atmospheric background 30.

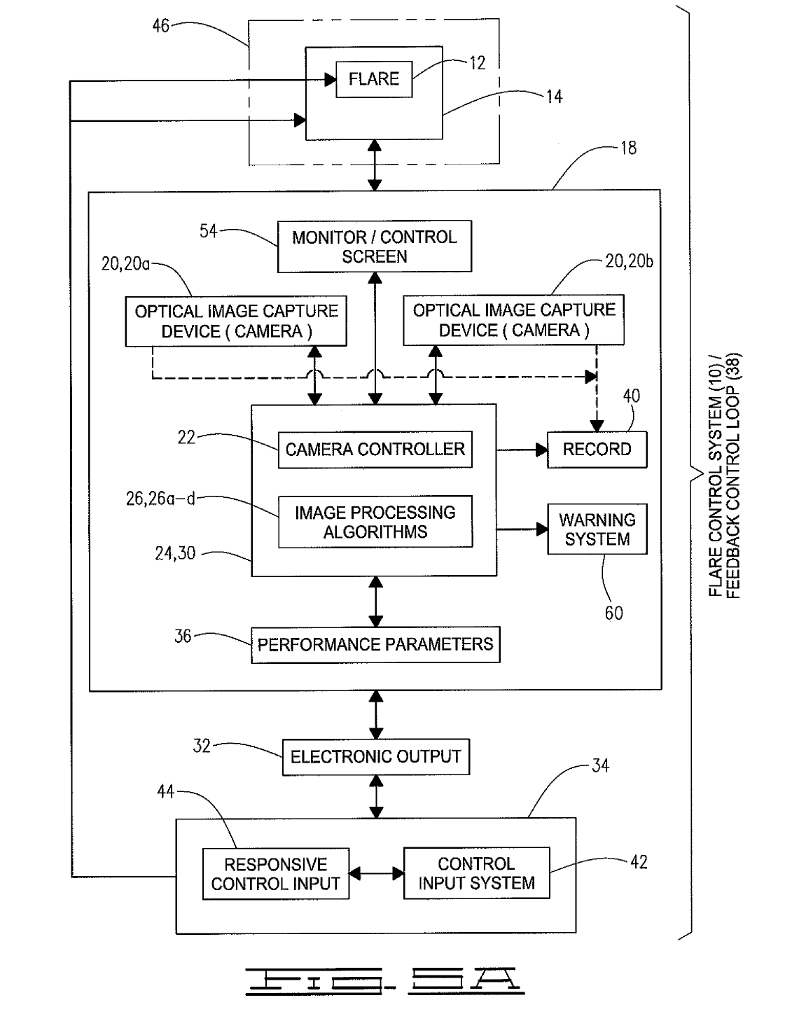

By way of a non-limiting example, a plurality of image processing algorithms 26 are contained within the illustrative box in FIG. 5A to represent the variability of functions the different algorithms provide. A first image processing algorithm 26a provides for analysis of the image from camera 20a and camera 20b. A second image processing algorithm 26b provides for discrimination between the image from camera 20a, camera 20b, and ambient environment 16. A third image processing algorithm 26c provides for de-integration of flame 56 within flare 12 and/or burner 14 into individualized pixels, thereby identifying and grouping the pixels into a plurality of spectral color groupings. Each image processing algorithm 26 provides for quantitative and qualitative analysis of the image from imaging system 18. By employing a plurality of image processing algorithms in parallel, additional evaluation parameters are available, and are discussed below.

With respect to image processing algorithm 26c, the image processing algorithm additionally provides for pixel counting and determining flame quality conclusions therefrom. By way of a non-limiting example, a 24-bit spectral color model is selected having blue, red and green, each spectral color having an intensity between 0 and 255. If the ratio of the total of the blue intensities in all of the isolated discrete pixels (the sum of blue intensities (0-255) for each pixel) is divided by the combined sum of the total of the red intensity and the total of the green intensity (the sum of red intensities (0-255) for each pixel plus the sum of green intensities (0-255) for each pixel) is known, the status, or flame quality ratio (FQR) of the flame is known.

$$FQR = \frac{\sum Blue pixel intensity ( 0 \text{-} 255 )}{\begin{matrix}\sum Red pixel intensity ( 0 \text{-} 255 ) + \\ \sum Green pixel Intensity ( 0 \text{-} 255 )\end{matrix}}$$

Alternatively, the FQR is calculated with averages rather than sums to give an identical result. Using this approach, a flame is luminous if the flame quality ratio is about 40% to about 55%. A flame has imminent smoke if the flame quality ratio is about 35% or less. And, a flame is over-diluted if the flame quality ratio is about 65% or more. A field test sample is illustratively discussed herein. Other spectral color models, such as 32-bit or 48-bit, may also provide additional data.

The flame quality ratios and associated ranges are fuel dependent. For example, in the case of hydrogen or methane, a biasing multiplier is entered into the image processing algorithms 26 to produce the desired flame quality ratio. Each installed flare 12 and/or burner 14 has an initial field test to establish the biasing multiplier required. The biasing multiplier is determined by manually adjusting flame 56 and comparing the calculated flame quality ratio against the actual condition.

Other parameters are also identifiable and analyzable by the specific image processing algorithm 26 selected. For example, a fourth image processing algorithm 26d provides for temperature sensing and detailed variations of temperature within flare 12 and/or burner 14.

Image processor 24, and the software thereon, is able to capture an image from camera 20 using a frame grabber. Image processor 24 is adapted to capture and analyze video and video signals from the group consisting of digital video, high-definition digital video, analog video and variations thereof. Additionally, image processor 24 is able to analyze analog video and convert the analog images to digital images as long as individual pixels are detectable in the analog images. The frame grabber portion of image processor 24 selects an individual image for processing. Preferably, at least one image processing algorithm 26 is adapted to identify an individual pixel in the video image of the flare.

Image processor 24 provides electronic output 32, which is communicated to automated flare control processor 34. Preferably, electronic output 32 identifies and provides at least one performance parameter 36 to automated flare control processor 34. Performance parameter 36 is the output from image processing algorithms 26 thereby providing the analysis on the ignition status, smokeless condition and destruction efficiency of flare 12 and/or burner 14. Similarly, the same, or at least one other image processing algorithm 26 provides performance parameters on the detachment of a flame from flare 12 or the buildup of smoke in flare 12 and/or burner 14. Automated flare control processor 34 may use the same computer as image processor 24.

The image from camera 20, or cameras 20a and 20b, as well as the resulting graphical user interface images are optionally displayed on a graphical user interface, or monitor/control screen 54. Monitor/control screen 54 is optional, but when utilized, monitory/control screen 54 is part of and is in electronic communication with image processor 24 and imaging system 18.

Preferably, image processor 24, imaging system 18, and automated flare control processor 34 define feedback control loop 38 therebetween. Feedback control loop 38 is adapted to analyze the image from imaging system 18. Additionally, feedback control loop 38 is able to simultaneously identify and monitor numerous performance parameters 36 of flare 12 and/or burner 14. By way of a non-limiting example, feedback control loop 38 is able to identify at least the temperature of flare 12 and/or burner 14; determine whether there is a soot buildup within flare 12 and/or burner 14; identify if the flame has detached from flare 12 and/or burner 14; identify if there is a color difference within the flame of flare 12 and/or burner 14; and identify a plurality of densities across the flame of flare 12 and/or burner 14. Another non-limiting example identifiable by feedback control loop 38 includes control of a smokeless, well-mixed flame 56 for the destruction of flare gas. Feedback control loop 38 can also identify hot spots in flare 12 or burner 14, check for pilot 48 “on” status, verify the destruction efficiency of flare 12 or burner 14, and identify any internal combustion within flare 12, burner 14, or pilot 48.

Recorder 40 is in electronic communication with imaging system 18. In one embodiment, recorder 40 is in electronic communication with image processor 24 and provides a date/time stamp on the images from optical image capture devices 20. Recorder 40 provides a logging function with a detailed date and time stamp imposed thereon for all conditions of flare 12 and/or burner 14.

Automated flare control processor 34 continuously, and at an operator set interval rate, defines a control input system 42 for flare 12 and/or burner 14. Based upon performance parameter(s) 36, automated flare control processor 34 generates a responsive control input 44 or adjustment to flame generation system 46. The same control input system 42 is applicable whether there is a single flare 12 and/or burner 14, or if there are a plurality of flares 12 and/or burners 14. Control input system 42 and responsive control input 44 directly communicate with the digital control system of a refinery, or other large facility. Alternatively, control input system 42 and responsive control input 44 provide direct input to flare 12 and/or burner 14.

Flame generation system 46 is adapted to respond to all control inputs related to flame generation and at least includes flare 12, burner 14, pilot 48, steam valve 50, and/or air generator 52. The devices in flame generation system 46 are preferably controlled in a precursory manner. Responsive control input 44 or adjustment is based upon the analysis of flare 12 and/or burner 14 from image processor 24. Electronic output 32 provides near-instantaneous statistical analysis of flame 56, thereby predicting the state of flare 12 or burner 14. Automated flare control processor 34 includes additional control algorithms. These additional control algorithms determine the increase/decrease of air, steam or gas input to flame generation system 46, or indirectly through the digital control system for flame generation system 46. Also, these additional control algorithms determine the best time interval for the input to minimize undesired conditions such as smoke, soot and dilution.

### Method

Regarding the method of controlling flare 12 and/or burner 14 depicted in FIGS. 1-5B, the method includes flare 12, or burner 14, discharging into ambient environment 16 and monitoring flare 12, or burner 14, by using optical-based imaging system 18, which has at least one camera 20. Alternatively, flare 12 or burner 14 is discharged to an enclosed or aesthetic flare. A digital image of flare 12 or burner 14 is captured by camera 20 as an electronic image, which may optionally be displayed on monitor/control screen 54. Analysis of the electronic image is done within image processor 24 by at least one image processing algorithm 26 that is adapted to analyze the flame of flare 12 or burner 14. Preferably, image processing algorithm 26 is capable of discriminating between flare 12 or burner 14, and ambient environment 16; capable of determining the status of flare 12 or burner 14; and capable of determining or predicting luminosity, color density, smoke, soot buildup, and flame. Alternatively, image processing algorithm 26 is capable of discriminating between flare 12 or burner 14, and the enclosed ambient environment of an enclosed or aesthetic flare or burner; capable of determining the status of flare 12 or burner 14; and capable of determining or predicting luminosity, color density, smoke, soot buildup, and flame. Flare 12 and/or burner 14 are adjusted based upon the analyzed condition of flare 12.

Imaging system 18 provides input to automated flare control processor 34 in order to make precursory quick, concise control changes to the input to flare 12 and/or burner 14 to avoid detachment of the flame, dilution, smoke creation, or any other undesired condition. Imaging system 18 evaluates the entirety of flare 12 or burner 14 to include smoke 62, pilot 48, shape of flame 56, and/or internal burning conditions.

By having camera 20a be an infrared or near-infrared camera, the discrimination between flare 12 or burner 14 and ambient environment 16 reduces the workload on image processing algorithms 26. Thus, the discrimination of the visible boundary between flame 56 and the ambient environment 16 is easier. Depending upon the particular application, it may be desirable to employ short-wavelength, mid-wavelength or long-wavelength infrared.

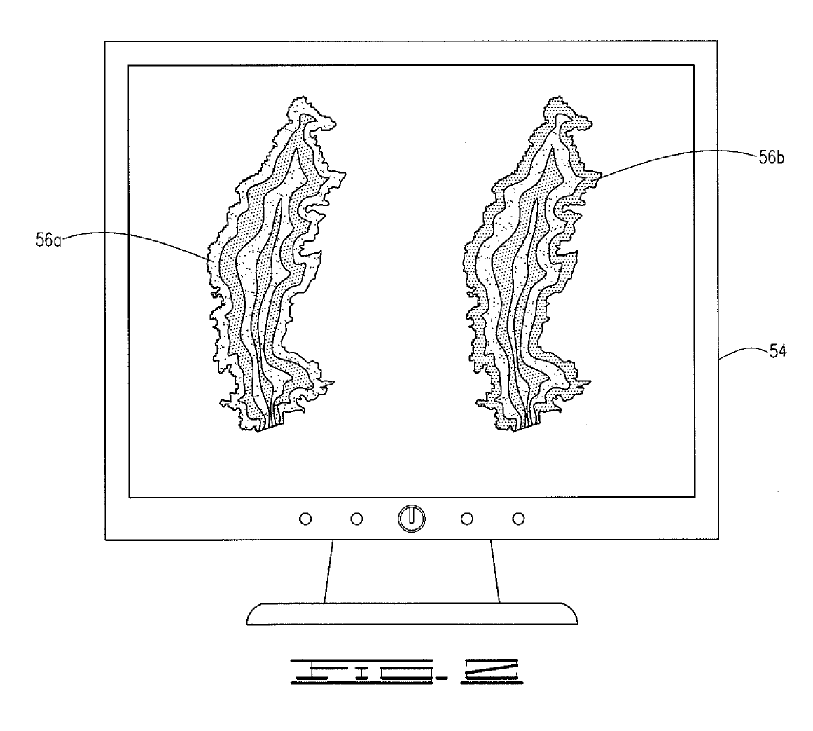

FIG. 2 illustrates a computer-displayed infrared image of flame 56a captured from flare 12 and having color striations represented by the lines in flame 56a. Also, illustrated in FIG. 2 is a computer-displayed image of flame 56b, which has been processed to subtract visible ambient environment 16 therefrom, thus presenting a rendered image of flame 56a. As in flame 56a, color striations of the flame are represented by the lines in flame 56b. Although the color striations are illustrated as lines in FIG. 2, some flames will produce turbulent eddies and dense bundles of colors, which create non-uniform color images within flame 56.

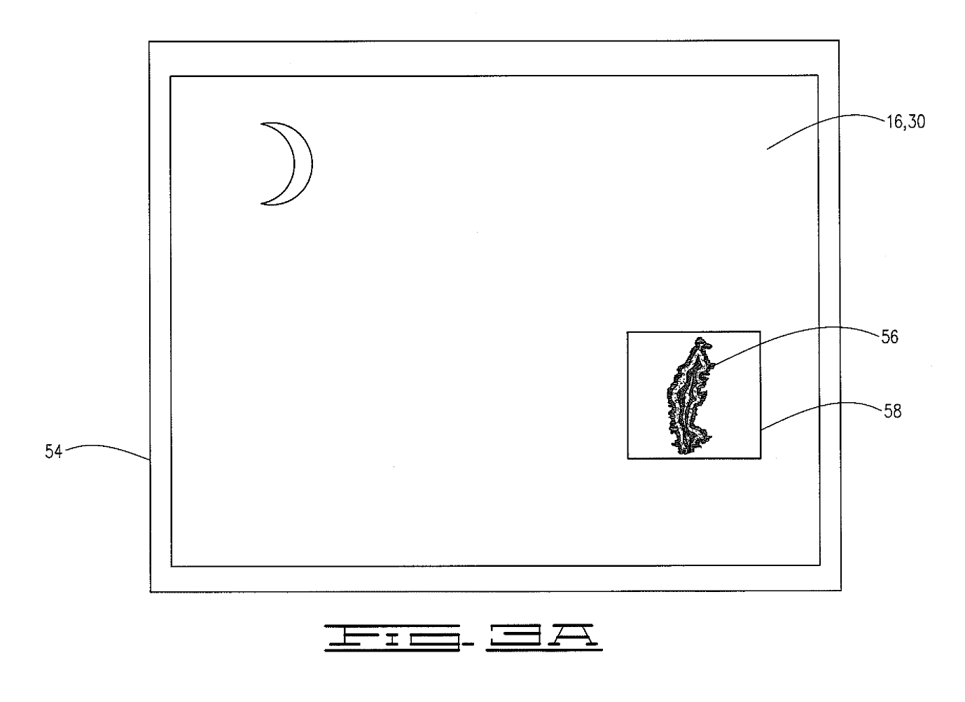

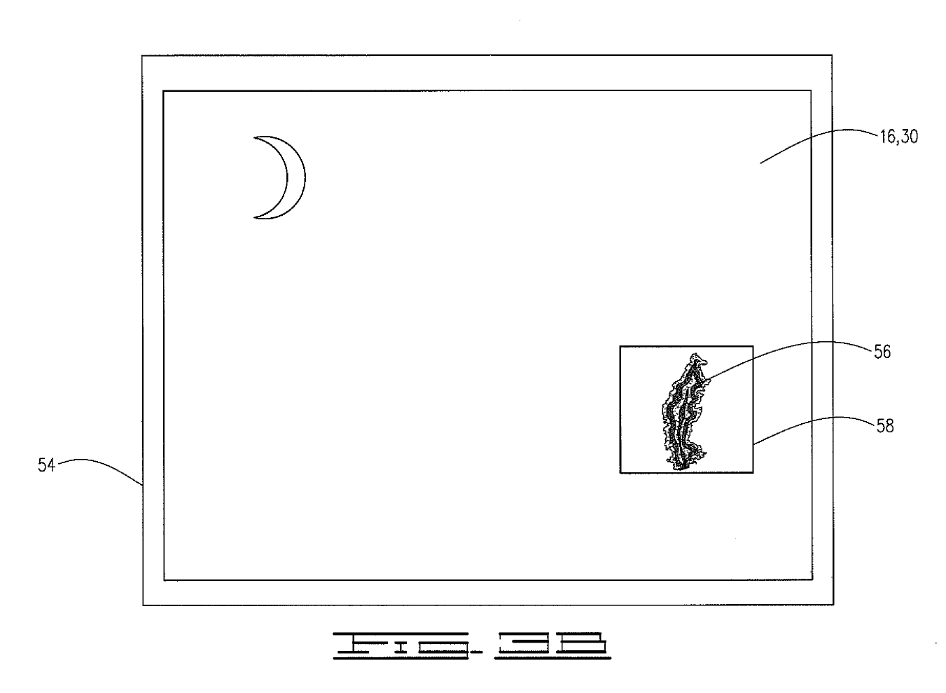

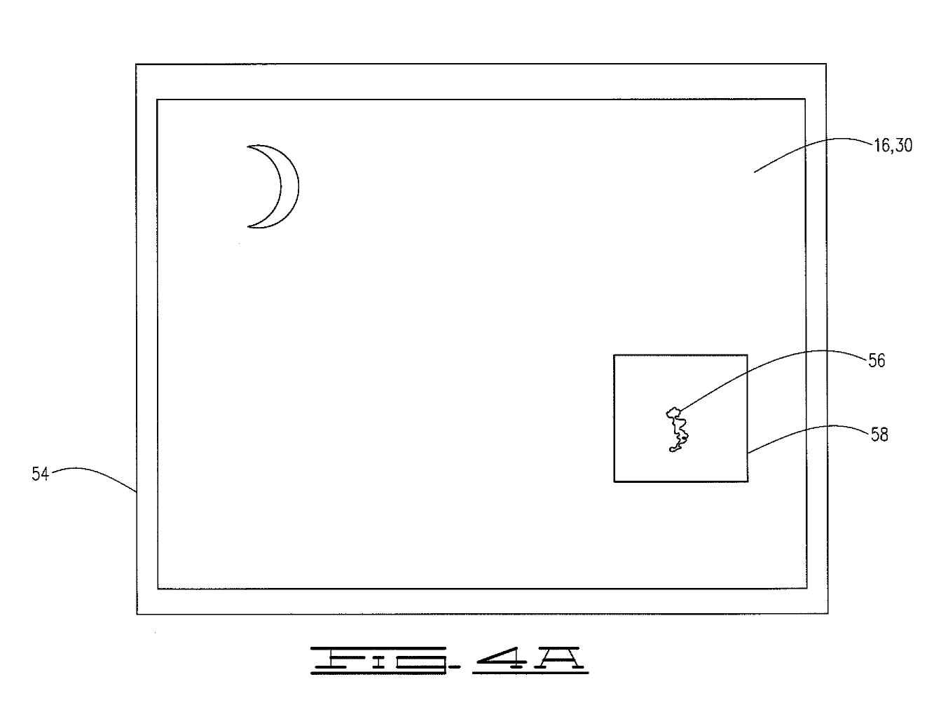

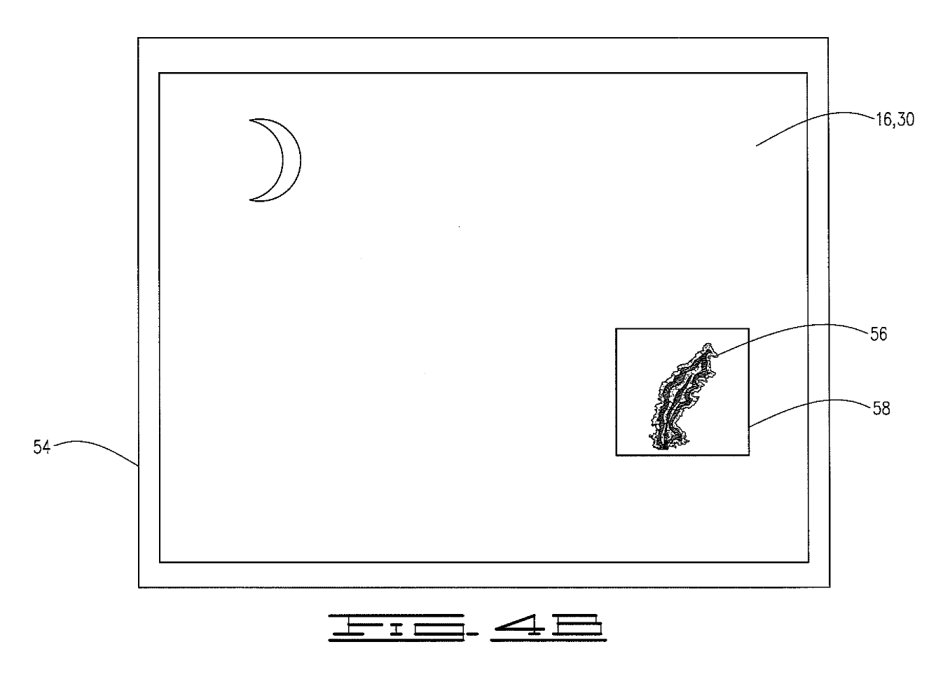

As illustrated in FIGS. 1 and 3A-4B, camera 20 includes first camera 20a and second camera 20b. In this instance, first camera 20a is an infrared camera 20a, and second camera 20b is a visible spectrum camera. Both cameras 20 are focused upon the image of the flame in flare 12, or burner 14. FIGS. 3A-4B depict both cameras 20a and 20b in use at nighttime and displayed upon monitoring/control screen 54. As depicted in FIG. 3B, infrared camera 20a has acquired flame 56, and working in conjunction with camera controller 22 of image processor 24, target box 58 is inserted around identified flame 56. As depicted in FIG. 3A, the same image depicted in FIG. 3B is shown from the visual perspective of a visible spectrum camera 20b, which is depicted as an un-zoomed, charged-coupled device (CCD) camera. Target box 58 is also depicted on FIG. 3A.

In one embodiment, first camera 20a and second camera 20b are separated to provide different angular views of flares 12 and/or burners 14. For example, first camera 20a and second camera 20b may be positioned to provide an appreciable angle of separation between them to capture the image of flame 56 in three-dimensions, relative to flares 12 and/or burners 14. The separation allows for at least one camera 20 to capture flame 56 bending away from the other camera 20. The appreciable angle must be sufficient to provide data for three-dimensional modeling.

When employing cameras 20 having a zoom function, the flame area is magnified. The magnification of flame 56 increases the number of photons seen by cameras 20, thereby increasing the number of usable pixels containing flame specific information. The larger number of usable pixels increases the statistical sample size, thereby increasing the precision of the evaluation and predictive capability.

In the embodiment using two or more cameras 20, camera controller 22 will provide instructions to visible spectrum camera 20b to capture the image within target box 58, as depicted in FIG. 3A, or to zoom-in on target box 58 and capture the image. FIGS. 4A and 4B are similar to FIGS. 3A and 3B, except flame 56 is not readily identifiable to visible spectrum camera 20b in FIG. 4A. However, FIG. 4B depicts infrared camera 20a clearly identifying flame 56. Thus, the particular visible spectrum camera 20b utilized, and the power of image processor 24 using image processing algorithm 26 is important to properly image flare 12 against open-air ambient environment 16, or the background of an enclosed or aesthetic flares. In either case, the image processing algorithms 26 identify boundaries 64 of flame 56 and electronically remove background information, thereby limiting the spectral information to the actual flame 56. Infrared is utilized to determine the size and shape of the flame for processing.

Infrared and near infrared cameras are preferred for first camera 20a, but any spectrum choice will work, including mid-wavelength infrared, and long-wavelength infrared. The boundaries established by using infrared are comparatively used with the visible spectrum to definitively identify the visible area for evaluation against one of image processing algorithms 26. Once the background is removed from the captured image, the infrared/near infrared allows for image processing that shows soot or smoke leaving flame 56. Individual soot particles making up the smoke are emitted at a measurable rate. Mid-wavelength infrared or long-wavelength infrared can then be used to identify pilots, internal burning, hot spots, soot build-up, temperature irregularities, etc. With a multiple-CCD camera, camera 20 can be a single lens system.

In the case where a plurality of flares 12 and burners 14 are being observed against ambient environment 16, imaging system 18 with image processor 24 is able to operably discriminate between each of flares 12 and burners 14, and provide adjustments in real-time through automated flare control processor 34 and flame generation system 46. For example, many flares 12 and/or burners 14 utilize steam, air, or both for control of the flame. The control input functions for the steam and air systems are part of flame generation system 46. As determined by feedback control loop 38 and the associated systems, steam input and/or air input are controlled and adjusted according to the analyzed condition of flare 12 and/or burner 14. This same process allows for control of all flame generation system 46 elements, including flares 12, burners 14, and pilots 48. When a plurality of flares are evaluated, image processing algorithms 26 include the capability for triangulation of images with one or more camera 20. Using multiple cameras 20, different values are modulated to manipulate different flares 12 and/or burners 14.

The analysis of flares 12 and/or burners 14 include using image processor 24 to qualitatively and quantitatively identify the various conditions impacting performance, and incorporating that analysis into instructions provided by automated flare control processor 34 to flame generation system 46. Since color-based qualitative and quantitative analysis from image processor 24 provides the input to automated flare controller 34, precursory determinations for flame generation system 46 are easily made. Thus, flare 12 may be changed as needed to keep soot/smoke at a minimum while maintaining high destruction efficiencies. The input to flare 12 and/or burner 14 of air or steam is reduced as needed.

This real-time adjustment step provides the necessary adjustments to flare 12 and/or burner 14, thereby negating the development of smoke or other undesired conditions. Because there is an inherent lag-time associated between the input to flame generation system 46 and the particular gas, air or steam input control, automated flare control processor 34 determines the best time interval for changes to the particular gas, air or steam input control.

The analysis of flare 12 and/or burner 14 provides analysis of flame 56, and provides critical information to the operator as to whether flame 56 is growing, decaying, out, or in a steady-state. In cases where feedback control loop 38 identifies conditions where flare 12 and/or burner 14 have undesired conditions of operation, warning system 60 and recorder 40 are available to provide notice and feedback to the operator, and to memorialize the event. Notice and feedback to the operator can be in the form of audible signals, electronic alerts, and/or visual queues. Memorializing the event includes imprinting the date and time upon the record, and transmitting that record to recorder 40.

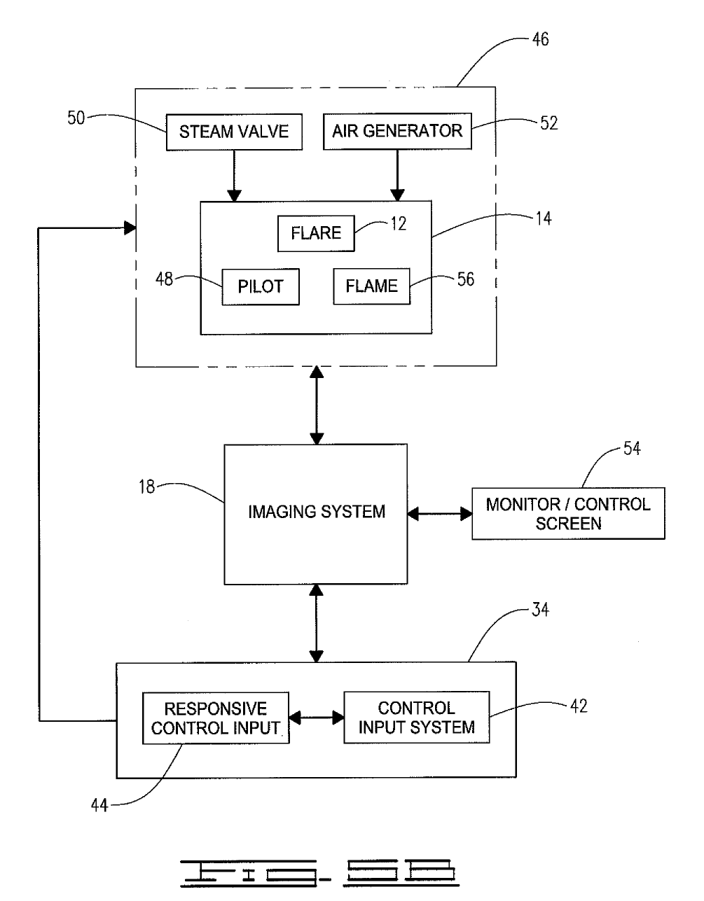

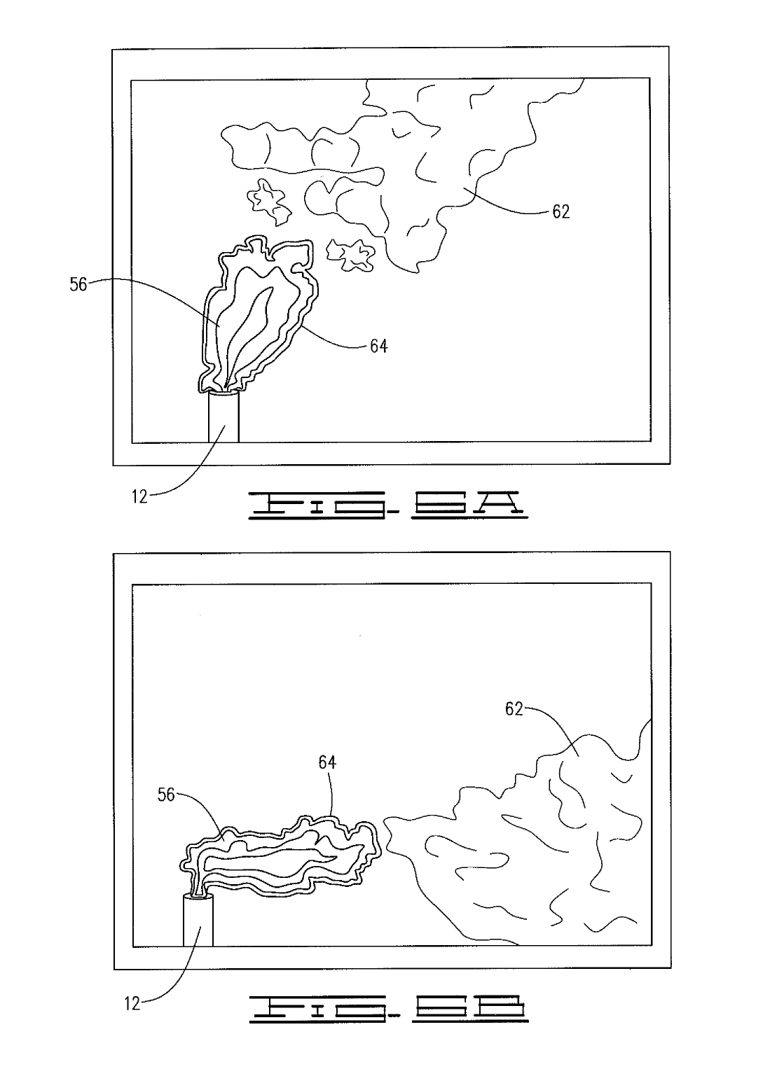

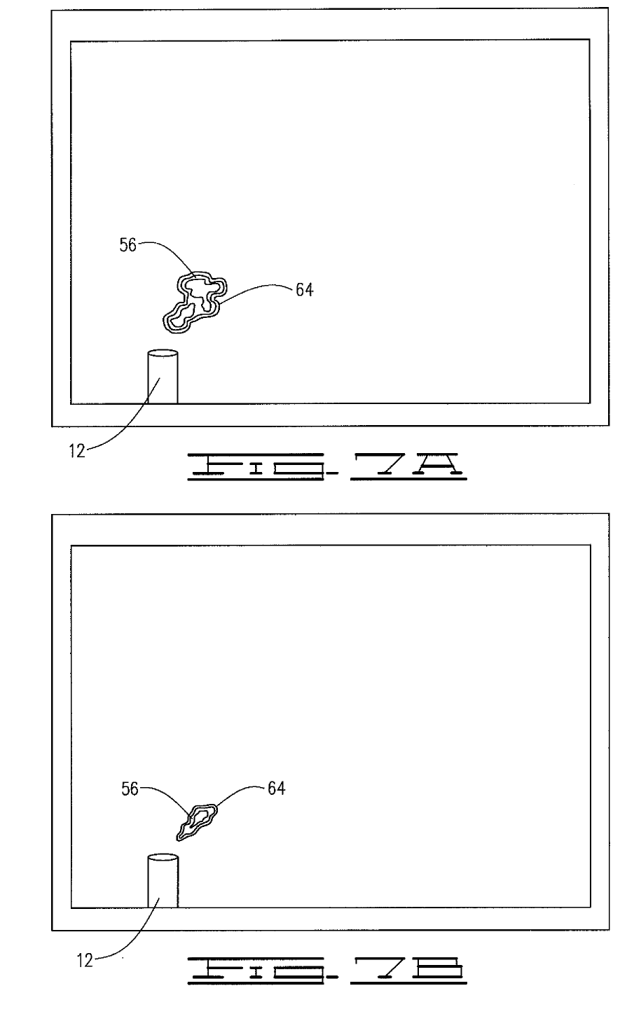

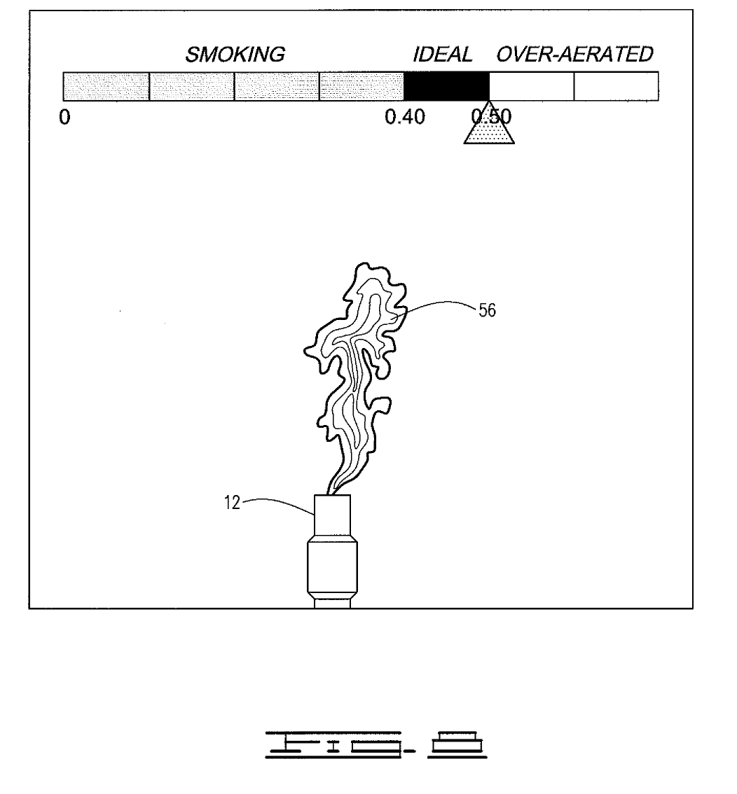

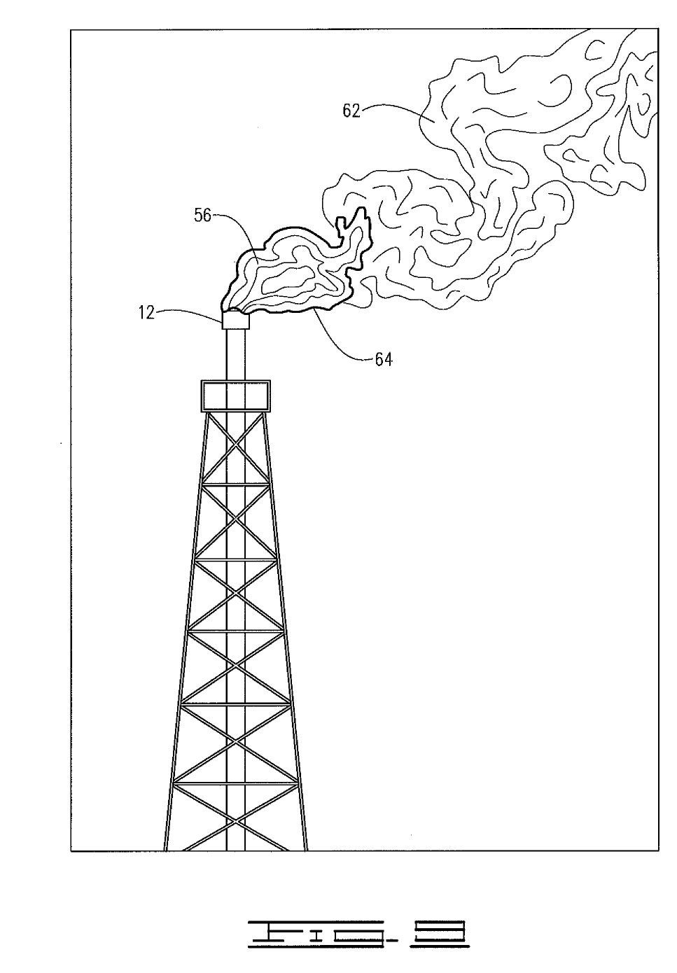

Other representative examples are illustrated in FIGS. 6A-8. In FIGS. 6A and 6B, smoke 62 is illustrated in conjunction with flame 56. In FIGS. 7A and 7B, a clean flame is illustrated. FIGS. 6A-7B show flare 12 having flame 56. Outline 64 indicates the boundary for the area of interest isolated by infrared camera 20a. After outline 64 is established, camera controller 22 focuses camera 20b upon flame 56 and outline 64, whereby camera 20b captures the image of flame 56 for image processing. In the representative examples, the pixels are grouped according to their color, and a pixel counting image processing algorithm 26 counts the number of each pixel in each group. As shown in the representative examples, FIG. 6A illustrates a flame that is producing smoke and has a flame quality ratio of 0.34. Similarly, FIG. 6B illustrates a flame producing smoke and having a flame quality ratio of 0.36. In contrast, FIGS. 7A and 7B illustrate a flame quality ratio of 0.53 and 0.54 respectively. FIGS. 7A and 7B illustrate a properly burning flame. FIG. 8 illustrates a properly aerated propane flame 56 with a flame quality ratio bar graph superimposed thereon.

Flare control system 10 and the method of use are sufficiently robust to detect flame 56 in flare 12 and/or burner 14 in various open-air ambient environmental conditions, and semi-enclosed or aesthetic flares exposed to those same environmental conditions. For example, open-air ambient environmental conditions include atmospheric conditions consisting of clear skies, cloudy skies, rain, snow, sleet, wind, dust and combinations thereof.

### Algorithms and Examples

Image processing algorithms 26 are mathematical expressions (e.g., using pixel coloration) and are used to provide performance parameters 36 in the form of electronic signals 32 so that automated flare controller system 34 and flame generation system 46 can make functional control changes in the delivered air flow to the flare tip. The algorithms allow for precursory indicators to be identified and evaluated such that changes can be made to flare 12 before soot/smoke are fully realized.

Pixel de-integration and evaluation allows the flame quality ratio of the blue light concentrations to be compared to fractions of red and green light concentrations, and possibly yellow light. This flame quality ratio is then compared to a verified and validated statistical range.

One of image processing algorithms 26 compares on-line light concentrations to a mathematical correlation, providing performance parameters 36 to automated flare controller system 34 with the appropriate functional changes to the flame generation system 46, as needed, to modify the stoichiometry of flame 56. Infrared may be utilized to isolate flame 56 under any conditions, and the visible spectrum is then utilized for analysis. This same infrared capability is used to isolate flame 56 for evaluation, which is then used to further determine pilot burner status, as well as whether flame 56 is stabilized inside the body of the flare tip. Flame 56 deeply seated inside the flare tip can damage the structural integrity of the tip over time. Utilization of an infrared detection device as a diagnostic tool can add significantly to the life expectancy of a given flare tip by using flare control system 10 to position flame 56 in the upper area of the tip during purge rate flows.

By way of a non-limiting example, one embodiment of the process of detection, including using one or more image processing algorithms 26, includes:
Camera 20a, an infrared or near-infrared camera, isolates flame 56, captures the image of flare 14 or burner 14, and electronically communicates the image to image processor 24
One image processing algorithm 26 inserts an infrared image boundary around flame 56
One image processing algorithm 26 removes the background of ambient environment 16 from the infrared-based captured image
One image processing algorithm 26 determines the visible spectrum, thereby determining the visible image
One image processing algorithm 26 compares the visible image to the infrared image boundary and removes the difference between the visible and invisible infrared, leaving only the true visible flame 56
One image processing algorithm 26 separates and counts the colors of the pixels from the visible image from the applicable color spectrums, thereby determining the flame quality ratio and its relationship to precursory smoke
The flame quality ratio is sent to automated flare controller 34, wherein control algorithms determine if a change is required, and if so, provide corrective input to flame generation system 46
Additional image processing algorithms, and/or control algorithms provide for secondary assessments such as pilot 48 status, temperature of flame 56, temperature of flare 12, burner 14 or pilot 48, determining if there is internal burning, etc.

### Operational Background

The following describes the operational background, theory of operations and how the inventive control system is utilized in connection with flare 12 and/or burner 14. The reference to flare 12 is used below, but it is understood that the reference to flare 12 encompasses burner 14.

The inventive flare control system 10 is utilized to help ensure that flares 12 (including steam flares and air flares) effectively and efficiently operate to destroy potentially undesirable constituents in the flare stream.

The inventive flare control system 10 can be used to provide an early warning prior to sooting of flare 12, and that precursory data can be used in feedback control loop 38 of flare 12 to modify the stoichiometry of the tip for optimum combustion and destruction efficiency. The system can reduce over-steaming and subsequent dilution using statistical processing of visual images by looking at flame color and luminosity near the flame root. For example, lighter colors (shifted toward the blue spectrum) and the absence of or greatly reduced luminosity can indicate flame detachment and over-steaming, or a degree thereof. Flame 56 eventually becomes invisible to the near-infrared as too much air or steam is applied. During dilutions conditions, the geometry of flame 56 in the visible spectrum can be identified. As flame 56 become lighter, the attachment of flame 56 suffers, and flame 56 visibly begins to move away from the tip. For such situations, the air or steam is reduced to flare 12 or burner 14 to reduce the dilution effect.

In order to initiate flame 56 at the exit, or even internally within flare 12, a flammable mixture needs to be achieved and an ignition source is needed to ignite the mixture. Flare 12 typically maintains several (e.g., three to four) redundant pilot burners 48 for ignition. Burners 14 run 100% of the time to ensure that an ignition source is available in the event that a flaring event occurs. An ignition source must always be available to flare 12, or flare 12 can no longer perform its job. The inventive flare control system 10 is used to ensure that the pilot burners are lit and ready to light the flare should a flaring event be initiated.

Problems have been noted when the combustible stream is either over-aerated or substantially diluted such that insufficient heat energy is available to sustain flame 56. When over-aerated or over-steamed, the combustible gas will not light until a proper stoichiometry or velocity is achieved. When over-steamed or over-aerated, the flare tip can discharge dangerous gas fractions into the environment. Such conditions are especially problematic with respect to purge rate flows or leak flows. This will continue until the flare gas volume is increased sufficiently or the steam/air injection is reduced such that a combustible mixture is again achieved and stabilized. Once again, the inventive flare control system 10 is used to ensure that the pilot burners are lit and ready to light flare 12 should a flaring event be initiated.

As the temperature of flame 56 increases, it will become more luminous and emit light within the visible spectrum. As flame 56 approaches the flow capacity of the fan, flame 56 then becomes more dependent on atmospheric air to complete oxidation. This creates rich stratified zones within the flame envelope. Soot or smoke typically begins to form in flame 56 as air constraints and/or mixing issues become an issue. As soot forms within flame 56, there is usually a darkening of flame 56, which can typically be seen by the human eye.

In accordance with the invention, it has been discovered that control changes can be made to the air and/or the steam based on information created by a high definition, color, or black and white camera that uses grey scale. It has also been discovered that certain colors within flame 56 become prominent and more concentrated just before the flare tip begins to create soot or smoke. As the soot and smoke become apparent, color shifts become visible within the flame, which indicates cooling. This is shown by changes in the visible colors of flame 56, noting shifts from the blue spectrum to the lower temperature red spectrum. Flame 56 becomes populated with darker orange-to-brown colors just prior to smoke formation. It is at this point incipient smoke can be seen forming within the boundaries of the flame. This color becomes denser until the point is reached that the area appears to break away from the main body of flame 56 to produce trailing smoke 62. With additional gas flow and no change in air, the stoichiometric relationship therebetween decreases and the trailing smoke 62 increases. The air is basically a fixed quantity, or at least asymptotic with increased gas flow. Once incipient smoke is achieved, the trailing smoke will increase with additional fuel flow. Without some input and change, flare 12 and/or burner 14 will continue to smoke with more pronounced smoke as fuel is increased.

In some cases, this same smoke 62 can be created by fuel gas that is blown away from the main body of the flame by crosswind issues. The surface area presented by a large flaring event can easily create an appreciable zone for crosswinds to break sections of the gas away from the main body of flame 56. When this happens, it can form either dilute zones without flame 56 or rich flame 56 zones capable of producing smoke 62. When low purge rate flows are discharged under very low pressures, the wind can easily dilute and strip away the unoxidized fuel fractions to create situations conducive to unwanted/unpermitted emissions.

When leaks or purge rate flows are encountered, a gust of wind can have a significant adverse affect due to low gas momentum. The gas is typically buoyant when warm, and rises in the wind stream. When blown away from the ignition source and flowing air/steam, the gas can escape unoxidized.

Field-testing of flare control system 10 has shown that a direct approach can be taken by looking at the flame quality ratio, the ratio of blue pixels to the red and green. The field-testing was done with a smoking and non-smoking flare to determine the numerical point at which the flare would begin to smoke. The visible portion of the electromagnetic spectrum ranges from red to violet, red being the lower temperature end of the visible spectrum, and violet and blue being the higher temperature end of the spectrum. As flame 56 becomes under-steamed/aerated, or over-aerated or steamed (quenched), flame 56 will begin to form soot/smoke. The solid particles of soot formed inside flame 56 will begin to block the radiation from flame 56 to produce a flame shifting in color within the visible spectrum. The measurable movement from the blue and violet end of the spectrum to the red and yellow end of the spectrum indicates this scenario. In many cases, this cooling of flame 56 can be detected digitally before flame 56 actually begins to cool significantly. This effect is largely due to lack of oxygen, or due to the quench effect of steam and air, or air as it cools the flame by dilution (over-steaming or excessive air).

Imaging system 18 is able to see the shift in color due to shifts in flame temperature on a second-by-second basis, or fraction of a second basis, if required. The pixels are compared against a numerical algorithm allowing changes to be made to steam or air rates before the flame begins to smoke profusely, or becomes detached and unstable. FIGS. 6A-9 are representative examples from the field tests.

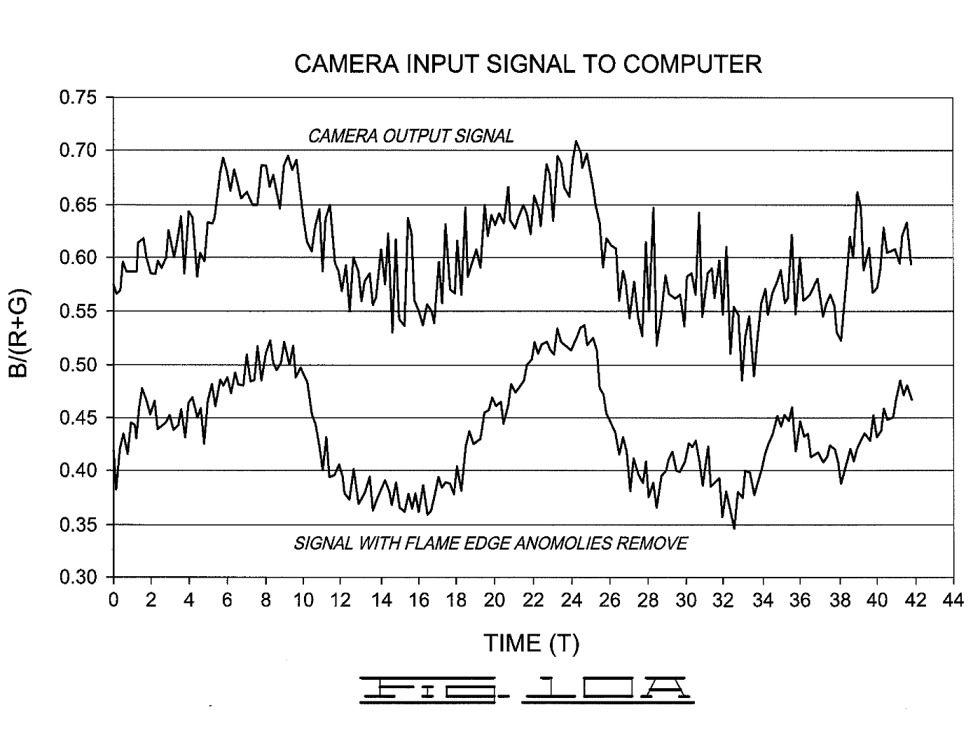

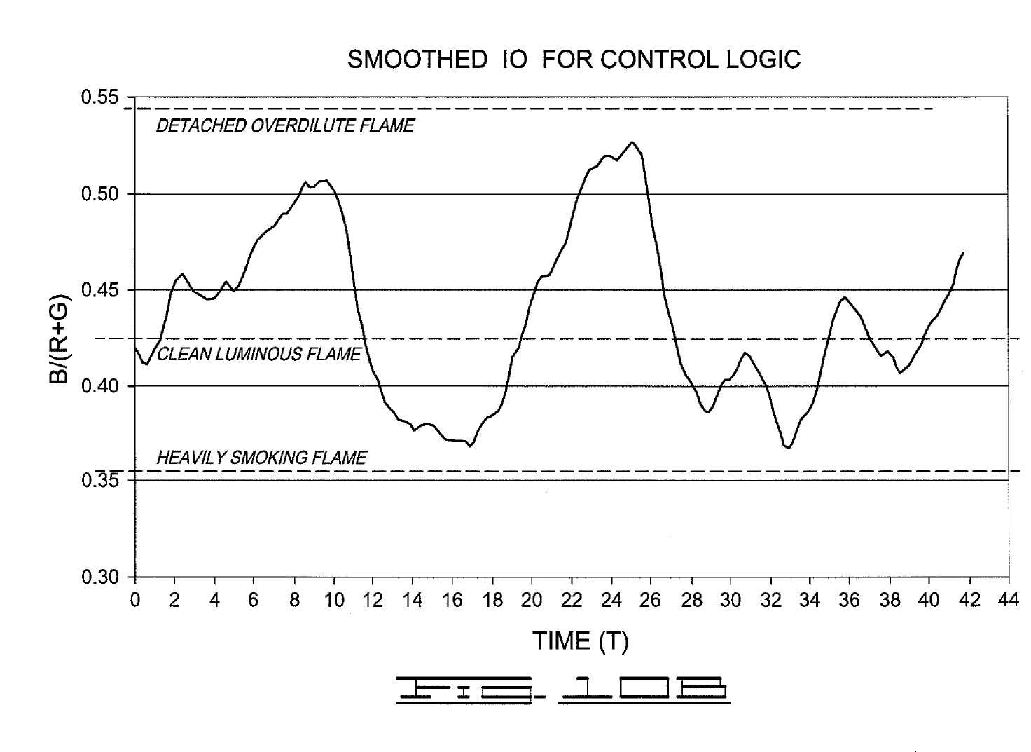

Referring to FIGS. 9, 10A and 10b, during a field test of flare 12, smoke 62 was emitting therefrom. Using first camera 20a and second camera 20b, the flame was repeatedly outlined and captured by imaging system 18, wherein the images were subjected to image processing algorithms 26. The resulting performance parameters 36 were communicated via electronic output 32 to automated flare controller 34, which provided control input to flame generation system 46.

Referring to FIG. 10A, the time history of the field test shows the camera output signal in terms of the flame quality ratio plotted against time. FIG. 10A also shows the computer processing of camera 20 output in terms of flame quality ratio plotted against time. Referring to FIG. 10B, the time history of the field test shows the predictive curve of flame 56 in terms of the flame quality ratio plotted against time. The predictive curve in FIG. 10B matches the measured curves of FIG. 10A.

Utilizing an image sensing device as a control system in accordance with the invention can be used to do the following:

### Visual Light Variations for Control

When operating flare 12 manually, it is very easy to see variations in color within a given flame 56. As flare 12 is about to smoke, flame 56 becomes darker and also has distinct colors relative to the area where smoke 62 is about to be formed. Flare testing has been done for years by simply varying the steam or air to suppress smoke.

An image sensing system, or imaging system 18, can be used to maintain the same color fractions/definition as if viewed by the human eye. This allows the same logic and decision processes to be initiated with an image sensing system for smoke negation to achieve automated control. For example, the image sensing system can be used to provide input to automated flare control system 34 to open a control valve for more steam, or change the pitch on a vane axial fan to offer more air whenever smoke is sensed. In either case, a control change is more calculated and can be made to enhance the flame created by a flare tip, thereby improving the effectiveness of flare 12 and the flare tip. Very precise changes can be made to optimize flame quality, stability, and destruction efficiency.

Similar to the human eye, imaging system 18 is able to discriminate between day/night and hot/cold sky in the visible spectrum. In addition to the visible spectrum, imaging system 18 is able to operate in at least the infrared and near-infrared spectrums. Additionally, the expansion to other spectrums, such as ultraviolet, is only limited by camera 20 and image processing algorithms 26. The infrared and near-infrared spectrums are well suited for heat signatures and identifying soot particles leaving the envelope of flame 56.

### Pilot Flame Verification

An image sensing device can also be used to sense ranges in temperature. Pilot burners 48 associated with a given flare tip must stay lit at all times to ensure the lighting capacity of the flare tip. In many instances, at least two distinct methodologies are required to monitor and determine the status of a pilot flame for redundancy. In most cases, these are done at the point of flame 56, making servicing the equipment difficult. It is not uncommon for flare tips to be mounted about 200 feet to about 400 feet (about 60 meters to about 120 meters) in the air. Image sensing is an additional methodology to determine if a pilot is lit, and to monitor the same pilot from the ground. An image sensing approach can detect a pilot flame in at least three distinct ways. First, the image sensing device can see the flame. If a redundant system is needed, the temperature of the flame shield around pilot 48 can be measured by infrared or thermal sensing using second camera 20b, or a multi-CCD camera. If the shields are hotter than ambient and beyond a programmed set point, it can be assumed a pilot flame is contained. Confirmation can be obtained by using a separate infrared camera in the mid-wavelength infrared or the long-wavelength infrared, which can sense the temperature of the shield. If the flame is out, the control system sounds an alarm or sends an alarm to the main control system. In some cases, the control system can then automatically try to relight the pilot until it is determined that such an effort will not succeed.

This same methodology is used to determine if flame 56 is contained deep within the body of the flare tip. If flame 56 is stabilized deep within the confines of the tip, a hot spot can be identified on the outside shell of the tip. Using the control devices disclosed herein to move the flame from the interior of the tip will allow the shell to cool, indicating the body of the tip is no longer jeopardized by an internal flame.

### Wind Issues

Flame 56 generated by a steam or air flare 12 can be extremely small with respect to purge rate flows. This same flare 12 can also produce an appreciably large flame 56 during an actual full-scale flaring event. For a very large flame 56 generated by a steam or air flare firing at a reasonable rate, a significant surface area for wind is presented. The pressure associated with the wind is then able to push against flame 56 such that flame 56 will begin to move off axis (bend). As flame 56 moves off axis, it also moves away from the high velocity air (and/or steam and air flow) needed to properly oxidize the flame. Testing has shown that the stoichiometric need of a flare is significantly affected by the amount of wind applied to the surface of the flame. In some cases, the greater the wind, the greater the stoichiometric need to keep the flame properly formed and free of smoke. During purge rate flows (appreciably small flames), the wind can have a significant impact on the dilution of flame 56. Wind effects, coupled with steam and air, and/or airflow can produce a process mixture that is no longer flammable. When this condition occurs, the normal destruction efficiency of flare 12 can be greatly decreased if not negated completely. Anything leading to a reduction in destruction efficiency can have a significant impact to both the environmental and the safety aspects of the flare in general. Knowledge of these issues allows operators to make conscious decisions to add or delete steam and air as required, positioning flame 56 near the design mixing zone to maintain optimum performance. This is done to keep flame 56 free of soot or smoke 62 when wind is appreciable.

When purge rate flows are observed, the steam and/or air may need to be reduced completely to maintain a flammable mixture. Again, the destruction efficiency of flare 12 ensures the gasses discharged are properly oxidized. In many instances, purge flows are more problematic than when an actual flaring event is realized. If operators set the steam and air such that minor flaring events will have sufficient flow without intervention, purge flows can be diluted to the point of non-flammability. Depending on the minimum required stoichiometry, a single set point, or threshold, can therefore be detrimental to the operation of flare 12. The inventive flare control system 10 becomes the best way to ensure an optimum operational range with proper destruction efficiencies. Also, flare control system 10 ensures proper stoichiometric mixing, coupled with proper flame positioning for the most effective combustion envelope and destruction efficiency.

Once again, imaging system 18 and automated flare control system 34 can be programmed to do the same thing an operator can do, only more accurately and with repeatability. Optical image capture device 20, or camera 20, can observe flame 56 continually and make adjustments to the steam or air flow to add additional momentum and mixing to flame 56 when needed to aid it in standing vertical. Keeping flame 56 vertical requires less air to maintain a smoke free flame envelope. Balancing of gas and air or steam must be exercised to ensure air or steam used to stand flame 56 vertically is not sufficient to cause subsequent dilution issues. A second evaluation is then needed to make sure the flame temperature remains within a sufficient range to keep flame 56 unquenched and stable. This ensures flame 56 is not compromised by adding too much steam or air. Constant evaluation with imaging system 18 and automated flare control system 34, and the control of flame generation system 46 ensures good flame combustion and quality, as well as gas destruction within.

### Detached Flame

As flame 56 begins to become over-steamed and/or aerated, flame 56 will begin moving vertically upwards away from the stabilizing geometry of the tip. This movement is in response to the reduction in flame speed in conjunction with dilution. Using optical image capture device 20 in conjunction with a visible or an infrared lens allows measures to be taken to prevent flame 56 of flare 12 from detaching from the normal stabilizing mechanism of the flare tip. Too much steam or air can lift flame 56 away from the discharge area and create instability. When flame 56 is visibly lifted and unstable due to being over-aerated or over-steamed, efficiency is compromised. Keeping flame 56 attached, and at a reasonable temperature for destruction, ensures that the combustion efficiency of the tip is maintained. It also avoids the low frequency noise typically associated with an unstable flame 56.

### Multiple Tip Evaluation

Using an optical image capture device 20 in a fixed position (or unfixed position in certain scenarios) allows imaging system 18 to evaluate multiple tips. Since the optical image capture device 20 can do anything the human eye can do, imaging system 18 is able to look at a plurality of enclosed or aesthetic flare burners to determine if they are properly lit, if they are unstable, and if they are breaking away (as could be the case in an Indair arrangement). Using automated flare control system 34, pressure can be lowered if burners 14 are found having problems with respect to stability or breaking away. Burners 14 can be turned off in the case of smoke 62 to allow pressure to build, or to allow the use of the low-pressure units. When smoke 62 is noted, the system can track the amount of smoke 62 and note the duration. It can also keep frame shots of the smoking tips to offer a historical video record.

Using an image sensing approach with optical image capture device 20 within imaging system 18 offers the ability to maintain a visual record of any event. The system can use a recorder, or screen capture, to take a date/time stamped frame shot, or image capture, to log, record and preserve the image of the condition. Logging of the event is important to document all out-of-permit operations. Because it can acknowledge smoke 62, imaging system 18 can then keep an image record at set intervals, such as every one or two seconds, or whatever time interval is set, until the system identifies that smoke 62 is no longer being formed. These image records have the date and time stamps stored therewith such that the image records become an unbiased historical document indicating how long the smoke was actually produced, to what level of opacity the smoke achieved, and to what extent the excursion reached. Accordingly, recorder 40 acts as an unbiased, third-party observer, and assures the credibility of the data.

In most cases, smoke 62 generated from a flare tip would be subjective to the person(s) viewing the event. Having imaging system 18 capable of capturing a true image of flame 56 allows for improved documentation of the actual event for how long, and to what extent. Since flame 56 occupies a number of pixels, a percentage of opacity within flame 56 is achievable. Further use of the frame shots, or image records can also show the amount of smoke trailing flame 56 during extreme excursions.

A Ringleman Number is typically applied to the effluent of flares 12 having opacity. The Ringleman Scale is a methodology utilized to delineate the density of the smoke created by a given flare tip, and whether, on an individual basis, the permit was exceeded. The Ringleman Number, however, can be highly subjective since few individuals are trained and know how to use it properly. A Ringleman Number generator is optionally part of flare control system 10 and used for documenting opacity. This capacity could then be indicated on the images as they are saved. These images would then serve as unbiased historical documentation showing the chronology of the event from incipient smoke, through trailing smoke, and back to the point in time where the flare has the flame again in compliance. Each historical image would have a date, time stamp, and Ringleman Number for the smoking event.

### Flame Inside Tip

A common problem associated with a flare tip is burning inside the tip as the tip sits dormant. In many cases, there are thousands of feet of upstream piping for a given flare system. In many cases, the valves from many different processes tend to leak, allowing small volumes of very low pressure gas to make its way to the flare tip. The heavier-than-air gas making its way to the flare tip, then builds up inside the tip for short durations. As the gas builds up in volume, it will eventually reach a flammable mixture and ignite from pilots 48. As the gas heats up during the day, it becomes more buoyant, thereby increasing the chances it will escape and combust. The typically heavier-than-air gas then sits inside the tip and burns until a flammable mixture no longer resides inside the tip. These conditions can be damaging to a tip if air or steam is not turned on to cool the tip and keep it from being damaged. There may also be issues with destruction efficiencies if the air or steam is set excessively high at a mechanical set point to quench the gas stream and allow its discharge without being properly oxidized.

Imaging system 18 can see this small flame by an infrared or visible light camera 20, when and if it is apparent. In combination with automated flare control system 34, it can then control the air and steam to keep the stream properly oxidized without detriment to the destruction efficiency of flare 12. It can also let operations personnel know there is a problem with upstream leakage so that maintenance can find and rectify the problem(s). Together, these processes will stop the gas that is making its way to the flare system to ensure no un-oxidized gasses are allowed to escape.

Configured appropriately, imaging system 18 and automated flare controller 34 can track the temperature range to which the flare tip is subjected. If the range in temperature becomes excessive, the steam and/or air can be increased until the hot spot is cooled. The historical capability of the system could then keep an ongoing log as to what temperatures were achieved, how long the temperatures were noted, and whether the temperatures were localized, or had migrated within the tip. Proper use of this type of tool could aid in extending the life of a given flare tip. Tracking the history of flame visibility as well as temperature range could also lend itself to determine any growth or decay of the discharge flow from the tip.

### Light Off

During light off, the use of imaging system 18 technology allows for the evaluation of almost any flare 12 type flame 56 to determine if a given tip is lighting off properly. Utilization of image-based flare control system 10 ensures that a single entity or a plurality of many burner tips are brought on line in such a way as to minimize smoke and maximize destruction efficiencies. An enclosed or aesthetic flare 12 system can have in excess of a hundred burners 14. The burners 14 are segmented such that several different header systems are employed. Each header will employ one or more pilot 48 burners to light the burners 14 on each header system. Ignition is initiated at one or both ends of the header system allowing burners 48 to light sequentially once the header system is populated with gas. Upon ignition of the initial burners 48, the time interval for sequential lighting of aligned burners 48 is very important in a properly operating system. If a single burner 48 fails to light in an aligned stage, the remaining burners 48 could take several minutes to light. During this time, gasses meant for destruction can be discharged into the atmosphere without being properly oxidized.

Imaging system 18 can continually watch a given flare 12 system to determine if burners 14 ignited when needed, how long it took them to light from one end of the header to the other, and initiate an alarm if there was a problem with the system. Operators can then take the appropriate action to address the situation. Again, problematic light offs can allow appreciable gas to be discharged into the atmosphere. Depending on how the unit is programmed, imaging system 18 and automated flare control system 34 can determine if there are pilot 48 problems, or if the system is lighting properly when activated. This can be as simple as determining the time it takes to light a complete line of burners 14 and comparing the information to historical data. If the time duration is changing, it could mean there are problems with the system. This serves as a pre-diagnostic of the system to let the operator know when things start to go wrong. As with the larger elevated flares 12, the system can also be programmed to be a historical file, documenting the length of a flaring event. Within the chronological timeframe of the event, the computer augmented system can log any problems with ignition, smoking during the discharge, the length of the flaring event, burners 14 that did not light, and the fractional amount of smoke 62 created using a Ringleman approach. The control system will ensure that the flaring system is always ready for any discharge by making sure the pilots are lit, and ready to ignite any flare gas presented to the flare tips.

The inventive control system can also be used in similar ways (as applicable) to monitor burners, pilots and other equipment that generate a flame.

Examples of flares 12, burners 14 and pilots 48 in connection with which the invention may be utilized include flares 12, burners 14 and pilots 48 shown by U.S. Pat. Nos. 5,810,575 (Flare Apparatus and Methods), 5,195,884 (Low NOx Formation Burner Apparatus and Methods), 6,616,442 (Low NOx Premix Burner Apparatus and Methods), 6,695,609 (Compact Low NOx Gas Burner Apparatus and Methods), 6,702,572 (Ultra-Stable Flare Pilot and Methods), and 6,840,761 (Ultra-Stable Flare Pilot and Methods), all of which are incorporated by reference herein.

Other embodiments of the current invention will be apparent to those skilled in the art from a consideration of this specification or practice of the invention disclosed herein. Thus, the foregoing specification is considered merely exemplary of the current invention with the true scope thereof being defined by the following claims.

We claim:

1. A flare control system comprising:
an optical-based imaging system including:
at least one image capture device oriented toward at least one flare being ambiently discharged;
an image processor including at least one image processing algorithm capable of electronically analyzing a captured image of the flare, and capable of discriminating between the flare and an ambient background; and
an automated flare control processor defining a control system for the flare, wherein the automated flare control processor controls the flare in response to analysis received from the image processor.

2. The flare control system of claim 1, wherein the image capture device further includes an infrared camera and a visible camera.

3. The flare control system of claim 2, wherein the infrared camera is a near-infrared camera.

4. The flare control system of claim 2, wherein the infrared camera is a broad-spectrum infrared camera.

5. The flare control system of claim 2, further comprising a camera control system, wherein the optical-based imaging system is in electronic communication with the camera control system, thereby providing real-time, interactive control to the infrared camera and the visible camera.

6. The flare control system of claim 1, wherein the image capture device is a multi-charged coupled device camera.

7. The flare control system of claim 6, further comprising a light splitter positioned in front a lens on the multi-charged coupled device camera, wherein the light splitter spectrally splits the image.

8. The flare control system of claim 1, wherein the image capture device further includes a near-infrared camera and a visible camera, wherein the near-infrared camera defines at least one aiming parameter for the visible camera electronically communicated through the optical-based imaging system.

9. The flare control system of claim 1, wherein the image processor analyzes video from the group consisting of digital video, high-definition digital video, analog video and variations thereof.

10. The flare control system of claim 1, wherein the image processing algorithm is adapted to identify an individual pixel in the captured electronic image of the flare.

11. The flare control system of claim 1, wherein the image processing algorithm provides analysis on an ignition status of the flare.

12. The flare control system of claim 1, wherein the image processing algorithm provides precursory smoke prediction analysis on a detachment of a flame from the flare.

13. The flare control system of claim 1, wherein the image processing algorithm provides precursory prediction of flame instability in the flare.

14. The flare control system of claim 1, wherein the image processing algorithm provide precursory prediction of smoke in the flare.

15. The flare control system of claim 1, further comprising a feedback control loop between the image processor and the automated flare control processor, wherein the feedback control loop is adapted to at least identify a temperature of the flare, a soot buildup, a flame detachment, a color difference, and a plurality of densities across the flame.

16. The flare control system of claim 1, further comprising a flame generation system which includes the flare, wherein the automated flare control processor provides control input thereto.

17. The flare control system of claim 1, further comprising a recorder, wherein the recorder records a flare condition along with a date and time stamp.

18. A flare controller comprising:
at least one flare ambiently discharging in the atmosphere;
an imaging system, the imaging system including:
at least two optical image capture devices, wherein at least one optical image capture device detects, locates and captures a flame in the flare, and at least one optical image capture device captures an electronic image of the flame;
an image processor, the image processor being at least a computer in electronic communication with the optical image capture devices;
at least one image processing algorithm hosted on the image processor, the image processing algorithm capable of analyzing the electronic image, wherein the image processing algorithm discriminates between the flare and the atmosphere; and
an electronic output generated by the image processor, wherein the electronic output identifies at least one performance parameter of the flare; and an automated flare control processor receiving the electronic output, the automated flare control processor generating a responsive control input to a flame generation system that includes the flare.

19. The flare controller of claim 18, further comprising an image capture control system operationally defining control of the optical image capture devices, including operational control and electronic communication between the optical image capture devices.

20. The flare controller of claim 18, wherein the optical image capture devices include a camera operating in the infrared/near-infrared spectrum, and a camera operating in the visible spectrum.

21. The flare controller of claim 20, wherein the optical image capture devices are selected from the group consisting of charged-coupled device cameras, high-definition cameras, analog cameras, color cameras, black and white cameras, grey-scale cameras and combinations thereof.

22. The flare controller of claim 18, further comprising a recorder, wherein said recorder records a flare condition along with a date and time stamp.

23. The flare controller of claim 18, further comprising a valve controller in electronic communication with the automated flare control processor, wherein the valve controller provides flow control to a steam input to the flare.

24. The flare controller of claim 18, wherein the image processor provides an electronic data file with qualitative and quantitative analysis of the flame.

25. The flare controller of claim 18, further comprising at least one set of flame generation equipment controlled by the automated flare control processor.

26. The flare controller of claim 25, wherein the flame generation equipment is adapted to control all aspects of flame generation including control of at least one flare, at least one burner, and at least one pilot.

27. The flare controller of claim 18, wherein the image processor includes a temperature sensing algorithm, wherein the temperature sensing algorithm provides for detailed variations of the temperatures within the flame.

28. A method for controlling a flare comprising:
discharging a flare in an open-air ambient environment;
monitoring the flare using an optical-based imaging system having at least one camera;
capturing the image of the flare as an electronic image using the camera;
analyzing the electronic image of the flare using at least one algorithm capable of predicting smoke, and at least one algorithm that is capable of discriminating between the flare and the open-air ambient environment; and
adjusting the flare based upon the analyzed condition of the flare.

29. The method of claim 28, further comprising a first camera and a second camera.

30. The method of claim 29, wherein the first camera is an infrared camera used to identify the flame of the flare, and the second camera is a visible spectrum camera used to focus in upon the flame and capture the electronic image.

31. The method of claim 30, wherein the infrared camera provides aiming information to the visible spectrum camera.

32. The method of claim 29, wherein the optical-based imaging system is able to discriminate the ignition status, flame detachment and smoke of the flare.

33. The method of claim 29, wherein the optical-based image sensor operably discriminates between a plurality of flares in real-time.

34. The method of claim 29, further comprising a steam input to the flare, the steam input being controlled and adjusted according to the analyzed condition of the flare.

35. The method of claim 29, further comprising an air input to the flare, the air input being controlled and adjusted according to the analyzed condition of the flare.

36. The method of claim 29, wherein the step of adjusting the flare includes controlling at least the flares, all burners, and all pilots.

37. The method of claim 29, wherein the analyzing step includes employing qualitative and quantitative algorithms capable of detecting temperature, flame soot, flame detachment, color discrimination within the flame, and density variations in the coloration bands.

38. The method of claim 29, wherein the image produced is sufficient to provide for analysis including pixel counting.

39. The method of claim 29, further comprising a warning system, the warning system providing an automated notice for at least a flame detachment, smoke, soot, flame on condition, and flame out condition.

40. The method of claim 29, further comprising a logging function, the logging providing a detailed date and time stamp for all conditions of the flare.

41. The method of claim 29, further comprising a step of pre-light off flare detection.

42. The method of claim 29, further comprising the step of smoke negation, wherein the adjusting step provides real-time adjustment to the flare, thereby negating development of smoke.

43. The method of claim 29, wherein the open-air ambient environment includes atmospheric conditions consisting of clear skies, cloudy skies, rain, snow, sleet, wind, dust and combinations thereof

44. The method of claim 29, further comprising the step of analyzing the flame and providing information on whether the flame is growing, decaying, out, or in a steady state.

45. An automatic flare control system comprising:
at least one flare;
an imaging system capable of electronically capturing a digital image of a flame generated by the flare; and
a computer system including software for analyzing the image captured by the imaging system.

46. The automatic flare control system of claim 45, wherein the imaging system includes an image processor, at least one optical image capture device and software for processing the digital image.

47. The automatic flare control system of claim 46, wherein the optical image capture device is a camera selected from the group consisting of charge-coupled device cameras, multi- charge-coupled device cameras, multi-spectral cameras, high-definition cameras, analog cameras, color cameras, black and white cameras, grey-scale cameras and combinations thereof.

48. The automatic flare control system of claim 45, wherein the image processor and software are adapted to convert an analog image to a digital image.

49. The automatic flare control system of claim 45, further comprising a flare controller, wherein the flare controller is in electronic communication with the computer, and the flare controller provides control to a plurality of flares based upon the analysis performed by the software on the computer.

50. The automatic flare control system of claim 45, wherein the software includes an algorithm capable of analyzing the digital image, and discriminating between the flare and an atmospheric background.

51. The automatic flare control system of claim 45, wherein the software is adapted to identify an individual pixel in the digital image of the flare.

52. The automatic flare control system of claim 45, wherein the software provides analysis on an ignition status of the flare.

53. The automatic flare control system of claim 45, wherein the software provides analysis on a detachment of a flame from the flare.

54. The automatic flare control system of claim 45, wherein the software provides analysis on a buildup of smoke in the flare.

55. The automatic flare control system of claim 45, wherein the software is adapted to identify a plurality of individual discrete pixels from the digital image of the flare in a visible wavelength spectrum of blue, red and green, wherein the software is adapted to define a flame quality ratio therefrom.

56. The flare control system of claim 1, wherein the image processing algorithm is adapted to identify a plurality of individual discrete pixels from the captured image of a flame from the flare in a visible wavelength spectrum of blue, red and green, wherein the image processing algorithm further adapted to define a flame quality ratio therefrom.

57. The flare controller of claim 18, wherein the image processing algorithm is adapted to identify a plurality of individual discrete pixels from the electronic image of a flame from the flare in a visible wavelength spectrum of blue, red and green, wherein the image processing algorithm is further adapted to define a flame quality ratio therefrom.

58. The method of claim 28, wherein the analyzing step further comprises using at least one algorithm to identify a plurality of discrete individual pixels from the electronic image of a flame from the flare in a visible wavelength spectrum of blue, red and green, wherein the analyzing step further defines a flame quality ratio therefrom.

59. The method of claim 58, wherein the flame quality ratio is the sum of the blue intensities for each pixel divided by the total of the sum of red intensities for each pixel plus the sum of green intensities for each pixel.

60. The method of claim 58, wherein the flame quality ratio is the average of the blue intensities for each pixel divided by the total of the average of red intensities for each pixel plus the average of green intensities for each pixel.
